(19) United States
(12) Patent Application Publication
(10) Pub. No.: US 2012/0167634 A1
(43) Pub. Date: Jul. 5, 2012

(54) APPARATUS FOR WINDING FILAMENTS OR STRANDS

(75) Inventors: Dominique Font, Saint Baldoph (FR); Jean-Francois Blanchard, Les Marohes (FR); Pierre-Jacques Font, Val D'Isere (FR)

(73) Assignee: OCV Intellectual Capital, LLC, Toledo, OH (US)

(21) Appl. No.: 13/394,344

(22) PCT Filed: Sep. 18, 2009
(86) PCT No.: PCT/IB09/07224

§ 371 Date: Mar. 22, 2012

(51) Int. Cl. B65H 54/28; C03B 37/022; C03B 37/12

(52) U.S. Cl. 65/529; 242/481.8; 242/472.8; 65/539

(57) ABSTRACT

A system and method for winding at least one continuous strand of material (210) on a rotating support (212) to form a strand package or cake includes a rotatable traversing apparatus (216) for causing the at least one strand of material to reciprocate along a length of the rotating support (212) for even distribution in forming the package or cake. A plurality of strands can be wound simultaneously, the traversing apparatus having a form and operating orientation that generally maintains a parallel separation of the several strands while being wound on the support. The strand material may be, for example, glass, and a winding system may further include a source of glass strands, including a source of glass fibers (102) and a grouping mechanism (108, 208) for grouping respective pluralities of glass fibers into respective strands of glass fiber.

### FIELD OF THE INVENTION

The present invention relates to winding filaments or strands comprising a plurality of filaments onto a rotating support to form a bobbin, cake, or the like.

### BACKGROUND OF THE INVENTION

It is generally known in the art to wind elongate filaments or strands onto a rotating support to form cakes (sometimes also referred to in the art as bobbins or packages or spools or rolls) of the wound material.

In the field of glass fiber materials, it is generally known to draw a plurality of glass fibers passing molten glass from a molten glass source through a bushing assembly having a plurality of bushings to obtain a corresponding plurality of glass fibers. A predetermined number of the thus obtained glass fibers are grouped to obtain a respective glass fiber strand (sometimes referred to in the art as a split).

One or more glass fiber strands are then wound on a rotatable spindle having an axis of rotation to form a cake or bobbin.

FIG. 1 is a schematic illustration of a conventional glass fiber strand winding system 100 in accordance with the foregoing.

Bushing assembly 102 includes a plurality of bushings through which a molten glass (from a conventional source of molten glass, not shown) is drawn to form a plurality (as many as several thousands) of individual glass filaments 104. A conventional sizing composition may be optionally deposited on glass filaments 104 by a conventional sizing device 106. In an example of a conventional sizing device, filaments 104 may be passed through or adjacent to the sizing device 106 to deposit a predetermined sizing composition, for example, by passing the filaments 104 against a surface (such as a roller) wetted with the sizing composition. The sizing composition may be useful, for example, for protecting the glass filaments from breakage or to enhance bonding with a reinforcing matrix, if used later to create a composite material.

Next, the filaments 104 are separated by a separating device 108 into several groups of filaments to obtain respective glass fiber strands (sometimes referred to as splits) 110, each glass fiber strand 110 having a plurality of filaments, up to about 200 filaments each. The conventional separating device 108 has, for example, a plurality of spaced apart teeth like a comb. Accordingly, each group of filaments is separated from other groups by the teeth of the separating device 108 to define the corresponding plurality of generally planar glass fiber strands 110.

The one or more glass fiber strands 110 are thereafter wound on a spindle or other elongate rotating support 112 to obtain a wound cake 114 of glass fiber strands.

It is known in the art to use a mechanical traversing apparatus 116 to laterally displace the one or more glass fiber strands along an axial length of the spindle 112 in order to distribute the glass fiber strands during winding, so as to obtain a cake 114 that is wound consistently and, particularly, that can unwound reliably when desired. The conventional traversing apparatus in FIG. 1 is indicated very schematically at 116, and generally functions by displacing the glass fiber strands 110 in a reciprocating fashion back and forth along an axial portion of the spindle 112 while the glass fibers strands 110 are being wound onto spindle 112, in order to create a uniform cake 114.

Some conventional examples of traversing apparatus 116 include devices driven to rotate about an axis, having various rectilinear and curvilinear bars, blades, surfaces, and the like that are inclined in predetermined orientations relative to the axis of rotation of the device. The conventional traversing apparatuses are placed so as to be in contact with the one or more glass fiber strands 110, downstream of the separating device 108 and upstream of the rotating spindle 112. The arrangement of the bars on the traversing apparatus 116, which selectively contact the glass fiber strands 110 as a function of the rotation of the traversing apparatus 116, generally displaces the glass fiber strands in a reciprocating fashion back and forth along an axis of rotation of the traversing apparatus 116 so as to deposit the glass fiber strands 110 along an axial length of the cake 114 being wound.

Examples of conventional traversing apparatuses are disclosed in, for example, U.S. Pat. No. 5,669,564; U.S. Pat. No. 3,292,872; U.S. Pat. No. 2,989,258; U.S. Pat. No. 3,946,957; U.S. Pat. No. 3,399,841; U.S. Pat. No. 4,239,162; U.S. Pat. No. 3,819,344; U.S. Pat. No. 3,861,608; U.S. Pat. No. 3,784,121; and U.S. Pat. No. 3,356,304.

As seen in FIG. 2, once several cakes 114 are wound, the plurality of respective glass fiber strands 110 wound about each cake 114 as illustrated in FIG. 1 is thereafter pulled from a plurality of cakes 114, as represented in FIG. 2. The several pluralities of glass fiber strands 110 taken from the plurality of cakes 114 are thereafter wound together to form a “roving assembly” (sometimes referred to as a “multi-end” (in reference to the amassed grouping of glass fiber strands) package) 120.

For example, in FIG. 2, each of the three cakes 114 may each comprise 12 wound glass fiber strands. To manufacture roving assembly 120, each group of 12 glass fiber strands from each cake 114 are taken together and wound to form the roving assembly 120. Thus, the roving assembly 120 should provide 36 glass fiber strands when it is unwound in subsequent use.

Roving assembly 120 is typically used as a source of continuous glass fiber, for example, for subsequent production of chopped glass fiber for use as a composite material reinforcement. In such use, the roving assembly is unwound at relatively high speed to provide the glass fiber for subsequent manufacturing processes. However, conventionally known defects in the manufacture of the roving assembly cause later problems.

One major defect is a variation in the number of strands wound in the final roving assembly. This can in turn cause variations in the amount of glass material that is actually in a given roving assembly, compared to an expected amount. In some cases, this problem can be traced back to manufacture of the cakes 114. In particular, if the respective glass fiber strands 110 are not kept at a desired separation while the cake 114 is wound, this can cause glass fiber strands 110 to stick together, sometimes over a non-trivial length, particularly after a sizing deposited by the sizing device 106 is cured. This problem can occur very quickly while the cakes 114 are wound, given the rate of winding (sometimes as much as 25 meters of strand material per second). In effect, there may be fewer glass fiber strands 110 than expected, because the strands adhere to one another.

Another conventionally recognized defect is the generation of loops in the strands in the roving assembly after the roving assembly 120 is wound. Most generally, this is caused by strands being unevenly (in a lengthwise sense) wound onto a respective cake 114 during manufacture. For example, in a cake having tapered or conical ends when seen from the side (similar to the truncated ellipsoidal form of cake 114 seen in FIGS. 1 and 2), the length of a given strand that is wound on the cake will be lower as a function of the proximity of that strand to an axial end of the cake. (As the diameter of the cake at its axial end is smaller than at its middle, the length of strands wound at the end of the cake is shorter than the length of strands wound towards the axial center of the cake.)

For example, in FIG. 1, the linear extent of leftmost glass fiber strand 110′ that is wound onto spindle 112 will vary depending on how far strand 110′ is from the left end A of cake 114, as the collective group of strands is reciprocally traversed by traversing apparatus 116. That is, a shorter length of strand 110′ will be wound onto spindle 112 when the strand 110′ is closest to end A of cake 114 because the diameter of the cake at that point is the smallest. Greater and greater lengths of strand 110′ are wound onto spindle 112 as the group of strands is traversed to the right by traversing apparatus 116 because the diameter of the cake 114 (corresponding to the instant position of strand 110′) progressively increases. Obviously, this variance is reversed when the group of strands is subsequently traversed towards the left.

Furthermore, when the group of glass fiber strands is considered collectively in this context, it is evident that at a given moment longer and longer lengths of the respective strands to the right of strand 110′, respectively, are wound on the spindle 112. Thus, each glass fiber strand is wound onto the spindle at different rates and when the cake is unwound, the respective strands pulled from a given cake will have different lengths. Theoretically, this effect cancels itself out in a “roundtrip” of the group of fiber strands (i.e., when the group of fiber strands completes a full trip in one sense and a return trip, thanks to traversing apparatus 116). However, that depends on keeping the strands in the same order as the strands 110 are traversed back and forth. As a practical matter, this happens rarely, at least partly due to problems with conventional traversing apparatuses.

Accordingly, when a collection of glass fiber strands is unwound from the cake 114, some of the glass fiber strands may be longer than others. This excess length is sometimes referred to as “catenary” and manifests itself as loose or slack portions of strand that tend to twist and loop.

Another possible cause of loops in conventional winding apparatuses is that the conventional traversing apparatuses may be too slow in causing the one or more glass fiber strands to change in direction in the above-described reciprocal movement. Particularly when more than one glass fiber strand is wound into a cake, problems with the required reciprocal movement can cause the plurality of glass fiber strands to linger or pause at one of the extreme ends of the traversing apparatus instead of smoothly changing direction along the traversing apparatus. Because the winding of the cake 114 onto spindle 112 is continuous, any significant pause in the traversing movement causes several layers of glass fiber strands to be quickly wound at a single axial point along the cake, instead of distributing the glass fiber strands along the cake 114 as it is wound. Combined with the previously noted problem of adhesion between strands, a cake suffering from these defects may be prone to problems during unwinding, such as “bird's nests” or tangles, when a disorganized, possibly self-adhered, portion of glass fiber strands is pulled en masse from the otherwise smoothly wound cake.

These tangles of glass fiber strands can cause significant disruption during production (bearing in mind that the entire process depends on the smooth and consistent winding and unwinding of glass fiber strands) and loss of product yields (as the tangled fiber strands cannot be used commercially).

It is therefore of interest to improve systems for winding glass fiber strands into cakes, taking into account the above-mentioned problems.

A previous attempt to address these types of issues led to using a traversing apparatus having an oblique cylindrical form, comprising a pair of bar supports and a plurality of straight bars or struts extending in parallel and regularly distributed about a circumference of the apparatus. However, the axis of rotation of this type of traversing apparatus is inclined relative to the direction of extension of the plurality of bars extending between the bar supports.

Prior art traversing apparatuses with curved bars suffer from problems as glass fiber strands slide along the bars, such as changes in strand separation (including mixing of the order of the strands during sliding), and inconsistent variations in sliding speed.

### BRIEF DESCRIPTION OF THE DRAWINGS

The presently described invention will be even more clearly understandable with reference to the drawings appended hereto, in which:

FIG. 1 is a schematic representation of a conventional system for winding a plurality of strands, particularly glass fiber strands, into a cake or the like;

FIG. 2 is a schematic representation of a conventional process of winding a roving assembly using multiple fiber strands taken from multiple cakes of the type represented in FIG. 1;

FIG. 3 is a perspective view of a traversing apparatus for fiber strands according to the present invention, relative to a spindle onto which the fiber strands is wound;

FIG. 4a is an end view of the traversing apparatus of FIG. 3, seen along an axis of rotation X of the traversing apparatus;

FIG. 4b is a partial side view of the traversing apparatus of FIG. 3 illustrating an angular relationship between respective bars of the apparatus;

FIG. 5a is a schematic representation of the orientation of first and second groups of primary bar members of the traversing apparatus of FIGS. 3 and 4, relative to respective conical surfaces;

FIG. 5b is schematic end view of the traversing apparatus, taken along its axis of rotation, further illustrating the orientation of the first group of primary bar members on an oblique conical surface;

FIG. 5c is the same schematic end view as in FIG. 5b, but illustrating the arrangement of the second group of primary bar members on another oblique conical surface; and

FIG. 6 is a partial perspective view of a traversing device according to the present invention illustrating effective planar surfaces defined by adjacent primary bar members of the traversing apparatus.

### DETAILED DESCRIPTION OF THE INVENTION

The present invention is directed to a traversing apparatus for use in a system for winding fiber strands, particularly but not necessarily only glass fibers, into a cake or the like. The traversing apparatus of the present invention has a geometry designed to evenly and consistently displace fiber strands, particularly, a plurality of fiber strands, onto a rotating spindle onto which the fiber strands are wound to form the desired cake.

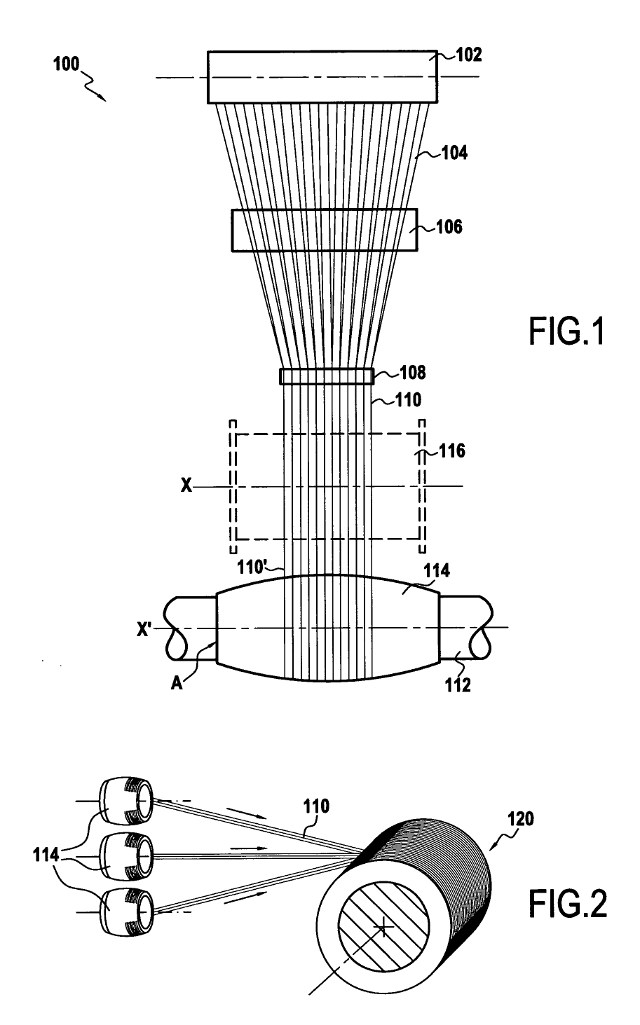

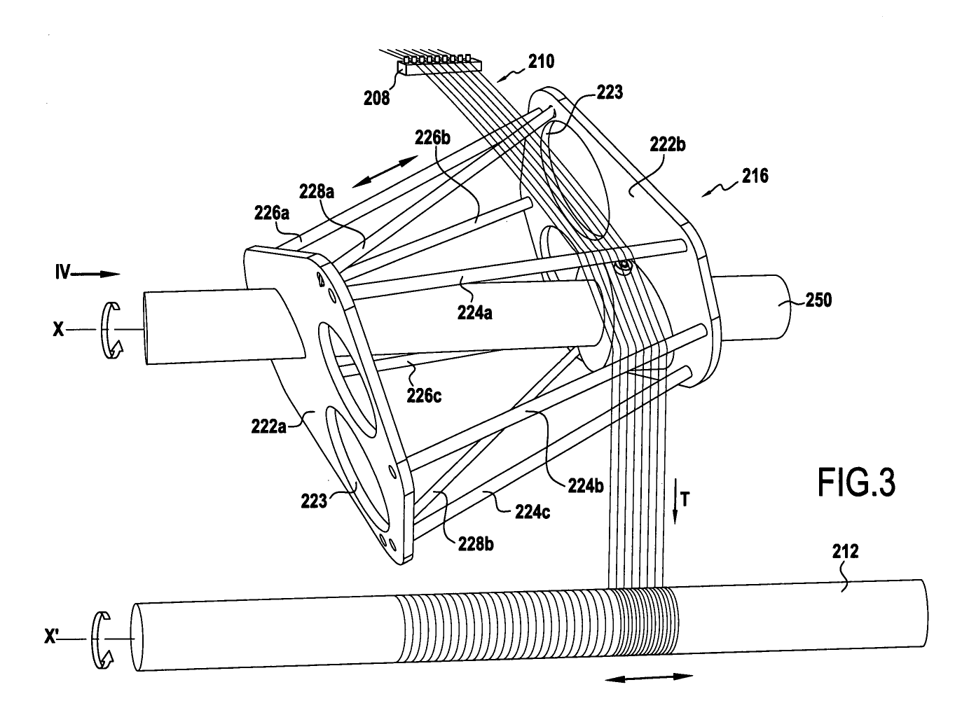

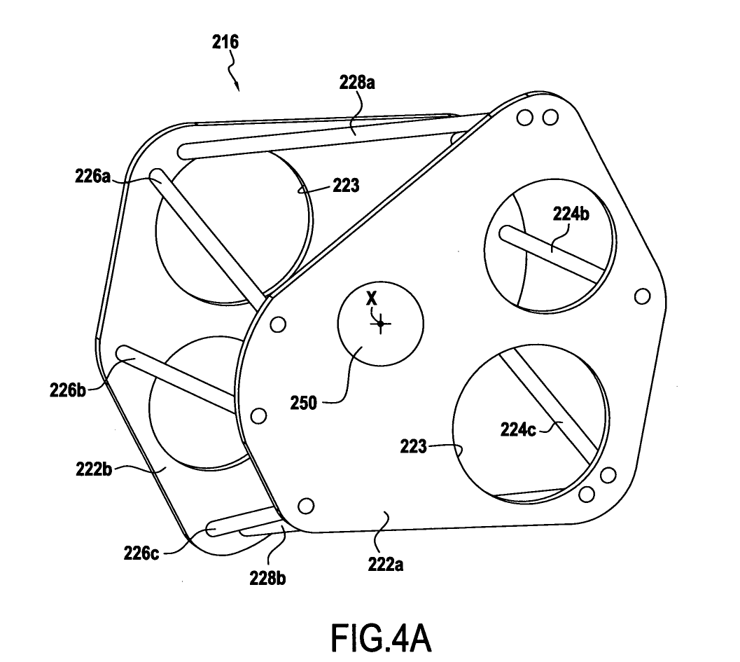

FIG. 3 is a partial detailed plan view of part of a winding system corresponding to that schematically illustrated in FIG. 1.

Specifically in FIG. 3, a traversing apparatus 216 according to the present invention is rotatably mounted on a shaft or the like 250. The shaft 250 is driven to rotate about an axis of rotation X by conventional mechanical drive means, such as a motor (not shown here). A rotatably mounted spindle 212 is provided downstream of traversing apparatus 216, and is driven to rotate about an axis of rotation X′ by conventional mechanical driving means, such as a motor (not shown here). Axis X′ may be generally parallel to axis X. As in the conventional system of FIG. 1, a plurality of spaced apart and generally parallel fiber strands 210 is wound about spindle 212. Fiber strands 210 are obtained from a source upstream of traversing apparatus 216. In one example, the fiber strands 210 are glass fiber strands, each glass fiber strand comprising a respective plurality of individual glass fibers drawn from a conventional bushing assembly 102 and grouped by a conventional separating device 208 such as that described with reference to FIG. 1.

In order to simplify the written description of the invention, a plurality of fiber strands 210 are mentioned herein, but the invention can be applied to a single fiber strand.

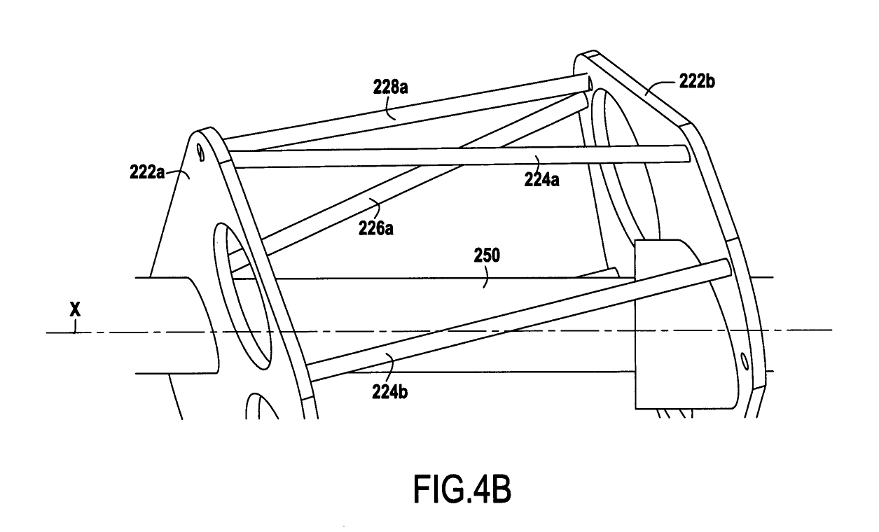

FIG. 4a is an end view of traversing apparatus 216 looking along axis of rotation X. Corresponding features in FIGS. 3 and 4a are correspondingly numbered.

In general, traversing apparatus 216 includes opposing first and second bar supports 222a, 222b. First and second bar supports 222a, 222b can be generally parallel with one another and are preferably, but not necessarily, skew relative to the shaft 250, as seen in FIG. 3. First and second bar supports 222a, 222b may optionally include one or more openings 223 formed therethrough, possibly to modify the weight of the apparatus as needed, to alter moments of inertia in the rotating apparatus, etc. Bar supports 222a, 222b are made of any conventional rigid material suitable for the operating environment, particularly with respect to temperature and with respect to chemical reactivity (the material should not chemically react) relative to fiber strands being wound and relative to any corresponding chemicals used. In one particular example, the bar supports 222a, 222b may be made out of metal generally, and may in particular be aluminum.

A plurality of bar members extends between respective peripheries of the first and second bar supports 222a, 222b. More specifically, a first group of primary bars 224a, 224b, 224c are adjacent to one another and extend between a part of the periphery of first bar support 222a and part of a periphery of second bar support 222b. Similarly, a second group of primary bars 226a, 226b, 226c extends between another part of the periphery of first bar support 222a and another part of the periphery of second bar support 222b.

The provision, as illustrated, of three primary bars in each group of primary bars is by way of example only. The number of primary bars in each group can be varied if the general geometric conditions described herein are respected. In general, the same number of primary bars is to be provided in the first and second pluralities of primary bars. Also, in general, a relatively small number of primary bars in each group is preferred, in part to reduce the overall friction caused by contact between the strands 210 and the primary bars.

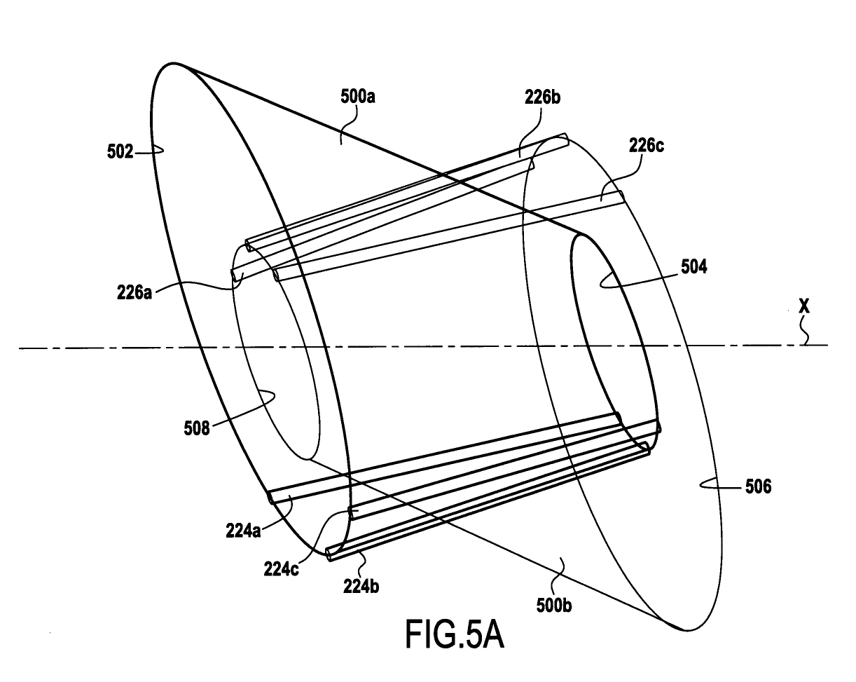

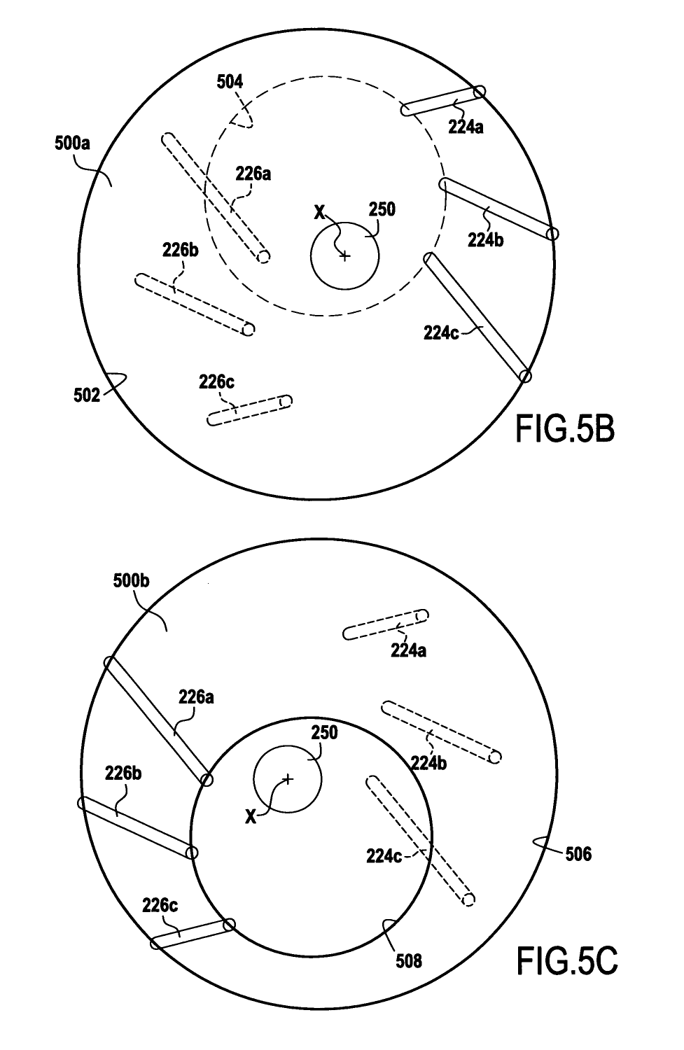

As will be discussed in more detail below, the first group of primary bars 224a, 224b, 224c is arranged relative to one another so as to lie on the surface of a first cone 500a. (See, for example, FIGS. 5A and 5B.) The second group of primary bars 226a, 226b, 226c is arranged relative to one another so as to line on the surface of a second, different cone 500b, oriented in a direction opposite to that of cone 500a. (See, for example, FIGS. 5A and 5C.) As will be appreciated more fully taking into account the description below, the primary bars of the first group 224a, 224b, 224c have a generally negative slope relative to the axis of rotation X along a direction from first bar support 222a towards second bar support 222b. Conversely, the primary bars 226a, 226b, 226c of the second group have a positive slope relative to the axis of rotation X along a direction from first bar support 222a towards second bar support 222b.

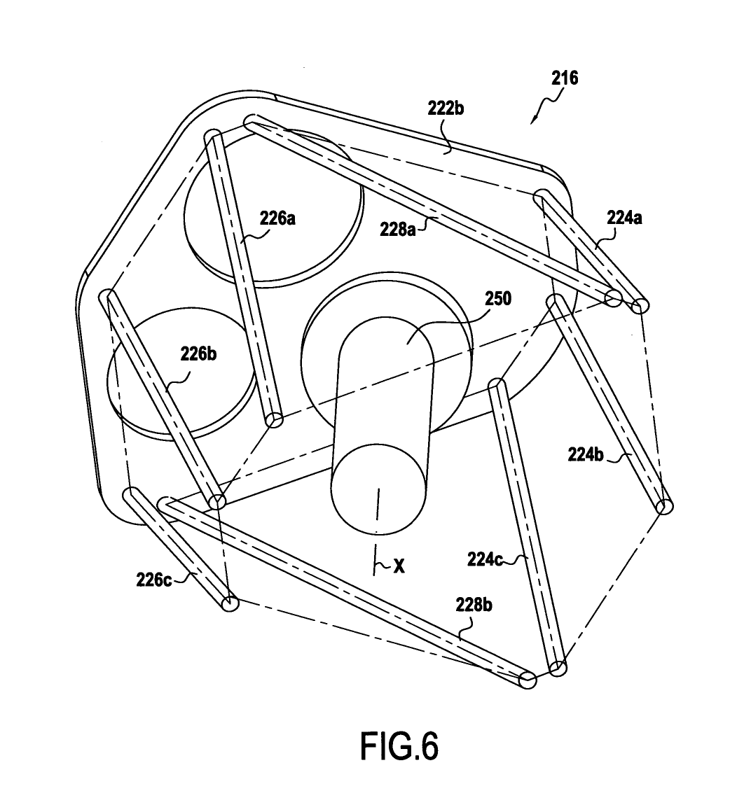

With this arrangement, primary bars 224a and 224b are coplanar, as are primary bars 224b and 224c. Likewise, primary bars 226a and 226b are coplanar, as are primary bars 226b and 226c. See, particularly, FIG. 6, which is a partial end view of the traversing apparatus 216 with bar support 222a removed to illustrate the relative planes defined by adjacent bars (indicated by broken lines). The coplanar relationship between the primary bars in each respective plurality of primary bars ensures a smooth sliding motion of the fiber strands 210 as each bar comes into contact with the strands 210 as the traversing apparatus 216 rotates in operation.

However, opposed primary bars of the first and second pluralities (that is, 224a and 226a, and 224c and 226c) are skewed (i.e., are not coplanar) relative to each other. See, for example, FIG. 4b and FIG. 6. More particularly, opposed primary bars of the first and second pluralities (224a, 226a; 224c, 226c) have different “signs” (i.e., bars 224a and 224c have negative slopes, while bars 226a and 226c have positive slopes, as discussed above).

If the plurality of fiber strands 210 were to be transitioned directly from bar 226a to bar 224a (or from bar 224c to bar 226c), the skewed relationship between the bars would negatively affect the smooth movement of the strands along the traversing apparatus. That is, if a plurality of fiber strands 210 were to transition directly from bar 226a to bar 224a, the fiber strands would in fact transition from all of the fiber strands 210 sliding along bar 226a in one direction at a certain velocity to a point at which a leading part of the fiber strands 210 slide onto bar 224a while a trailing part of the fiber strands 210 remain in contact with bar 226a (the traversing apparatus rotating away from the reader in FIG. 3 in the sense of the arrow shown about axis X). Keeping in mind that the slope of bar 226a tends to cause the fiber strands 210 to slide in a first direction, the opposing slope (i.e., having an opposite sign) of bar 224a would impart a “conflicting” impulse to the fiber strands 210 to start sliding in the opposite direction, causing the group of fiber strands 210 to bunch together and disrupt the desired separation of fiber strands. It will be appreciated that this will directly cause the separation and movement of the fiber strands 210 to be upset, and will negatively affect how the fiber strands 210 are wound onto spindle 212. In particular, this disruption of smooth travel of the fiber strands 210 can even cause stresses sufficient to break the fiber strands 210 and will random placement of the fiber strands 210 on spindle 212.

To address this problem, auxiliary bars 228a, 228b are provided.

First auxiliary bar 228a extends between first and second bar supports 222a, 222b, between primary bar 224a of the first group and primary bar 226a of the second group. More specifically, first auxiliary bar 228a extends from a location on first bar support 222a closely adjacent to the end of primary bar 224a located on first bar support 222a. First auxiliary bar 228a is mounted at the second bar support 222b at a location closely adjacent to the end of primary bar 226a located on the second bar support 222b.

Second auxiliary bar 228b extends between first and second bar supports 222a, 222b, between primary bar 224c and primary bar 226c, in a manner similar to first auxiliary bar 228a.

By orienting the first and second auxiliary bars 228a, 228b in this manner, each auxiliary bar 228a, 228b in effect changes the sign of its slope when the traversing apparatus 216 rotates, so as to provide a continuous transition from negatively sloped bar 224a to positively sloped bar 226a, and from negatively sloped bar 224c to positively sloped bar 226c (or vice versa, depending on the direction of rotation of the traversing apparatus 216 about axis X).

As is clearly illustrated in FIG. 6, for example, the presence of first auxiliary bar 228a between primary bars 224a and 226a addresses the skew relationship between primary bars 224a and 226a. Primary bar 224a and first auxiliary bar 228a are coplanar, and first auxiliary bar 228 and primary bar 226a are coplanar. Thus, as the traversing apparatus 216 rotates, fiber strands 210 sliding along the respective bars of the apparatus can smoothly transition between primary bars 224a and 226a, thanks to intermediate first auxiliary bar 228a. As mentioned above, if first auxiliary bar 228a were not present, the traversing motion of the fiber strands 210 would be irregular and discontinuous as the strands moved from contact with bar 224a to contact with bar 226a, because bars 224a and 226a are skewed relative to each other.

Likewise, the provision of second auxiliary bar 228b between primary bars 224c and 226c addresses the same problems as the provision of first auxiliary bar 228a.

Returning to FIG. 3, the rotating spindle 212 imparts a tensile force T in the fiber strands 210 while winding the fiber strands 210 thereon. Traversing apparatus 216 is positioned relative to spindle 212 in operation so as to at least slightly deflect fiber strands 210 along a direction generally perpendicular to tensile force T so as to generate a force component pointing generally radially inward (i.e., generally towards shaft 250). This generated force component tends to press the fiber strands 210 against the bars of the traversing apparatus. In particular, the respective bars of the traversing apparatus 216 are arranged (as discussed further below) in order to cause the fiber strands 210 to be pressed against adjacent bars in sequence (such as bars 224a, 224b in FIG. 3). The bars which contact the fiber strands 210 progressively change as the traversing apparatus 216 rotates about axis X.

As mentioned, a respective pair of adjacent bars (whether primary or auxiliary) are arranged so as to be coplanar. The fact that the bars are coplanar helps generate a continuous motion of the fiber strands 210 as they slide along respective bars as the traversing apparatus 216 turns.

In addition, each adjacent pair of bars either converges or diverges relative to one another along a direction from the first bar support 222a towards the second bar support 222b. The “rate” of the convergence or divergence of bars (i.e., how rapidly the bars converge or diverge over the distance between the first and second bar supports 222a, 222b) varies between respective pairs of bars. In a specific non limitative example, it is relatively greatest between first and second auxiliary bars 228a, 228b, and the primary bars to either side thereof; that is, between first auxiliary bar 228a and bars 224a and 226a, respectively, and between second auxiliary bar 228b and primary bars 224c and 226c, respectively. As mentioned previously, first auxiliary bar 228a extends from a location on the first bar support 222a relatively close to an end of primary bar 224a (and comparatively distant from an end of primary bar 226a), to a location on the second bar support 222b relatively close to an end of primary bar 226a (and comparatively distant from an end of primary bar 224a). Similarly, second auxiliary bar 228b extends from a location on the first bar support 222a relatively close to an end of primary bar 224c (and comparatively distant from an end of primary bar 226c), to a location on the second bar support 222b relatively close to an end of primary bar 226c (and comparatively distant from an end of primary bar 224c). See, for example, FIGS. 3, 4b, and 6.

As the traversing apparatus 216 rotates about axis X, different ones of the bars (primary and auxiliary) are sequentially pressed against fiber strands 210. Each of these bars is at a respective angle relative to axis X, taken in a direction from the first bar support 222a towards the second bar support 222b. These variations are obtained by appropriately mounting respective ends of respective bars to the first and second bar supports 222a, 222b. More particularly, a given bar is mounted so that its first end is mounted to the first bar support 222a at a given distance from the axis X (with respect to a plane in which the axis of rotation X lies), whereas its second end may be mounted to second bar support 222b so as to be at a greater distance from axis X (resulting in positively angled bar, relative to axis X in the direction from first bar support 222a to second bar support 222b), or the second end may be mounted at a smaller distance from axis X at the second bar support 222b (resulting in a negatively sloped bar).

In view of the foregoing, the first group of primary bars (224a, 224b, 224c) are arranged relative to each so as to extend between a periphery of the first bar support 222a and a corresponding periphery of the second bar support 222b. As can be seen in, for example, FIGS. 3 and 6, the bars 224a, 224b, 224c are relatively spaced apart at the first bar support 222a, and converge towards each other so as to be relatively close to one another at the second bar support 222b. Conversely, the second group of primary bars (226a, 226b, 226c) are relatively close together at the first bar support 222a and diverge so as to be relatively spaced apart at the second bar support 222b.

The magnitude of the slope of each of the primary bars can be different. For example, the slope of each of the primary bars 224a, 224b, 224c may progressively increase (i.e., become more negative) or decrease (i.e., become less negative), depending on the direction of rotation of the traversing apparatus 216). Likewise, each respective primary bar 226a, 226b, 226c may become increasingly or decreasingly positive. By adjusting the magnitude of slope of each pair of sloped bars (positively or negatively), the movement of the fiber strands 210 sliding along the bars can be further controlled (particularly with respect to the speed at which the fiber strands 210 slide along the primary bars).

In general, the cyclic transition from the negatively sloped first group of primary bars 224a, 224b, 224c to the positively sloped second group of primary bars 226a, 226b, 226c as the traversing apparatus 216 rotates drives the desired reciprocal traversing movement of the plurality of strands 210. More specifically, the negatively sloped primary bars 224a, 224b 224c tend to cause the fiber strands 210 sliding therealong to slide towards the second bar support 222b. Conversely, the positively sloped primary bars 226a, 226b, 226c tend to cause the fiber strands 210 to slide towards the first bar support 222a. By inducing this reciprocating movement of the fiber strands 210, the fiber strands 210 are caused to move back and forth along an axial length of the spindle 212 so as to evenly form a cake.

The primary and auxiliary bars are made of a material suitable for permitting the fiber strands 210 to slide therealong as described above without excessive friction, which can damage the fiber strands 210. The material of the primary and auxiliary bars should also be appropriate for the environment in which the winding operation takes place, taking into account, for example and without limitation, temperature and potential chemical reactivity with the material used to make the fiber strands 210. Depending on the particular application, some appropriate materials for making the primary and auxiliary bars are metal, resin (optionally reinforced with glass fibers), or wood. The bars may be attached to the first and second bar supports 222a, 222b by conventional means appropriate to the material of the bar supports and the material of the bars. Metal bars could be welded or soldered to metal bar supports, or, as illustrated in FIGS. 3 and 4 by way of example, ends of the respective bars could be fixed in holes formed in the bar supports.

Geometrically, the first group of primary bars 224a, 224b, 224c and the second group of primary bars 226a, 226b, 226c can be considered as lying on respective conical surfaces. For example, FIG. 5a schematically illustrates primary bars 224a, 224b, 224c arranged on a frustoconical surface 500a. Likewise, primary bars 226a, 226b, 226c are arranged on the surface of a second frustoconical surface 500b. The frustoconical surfaces 500a and 500b are oriented in generally opposite directions. (It should be noted that “conical” and “frustoconical” as used here should be considered effectively interchangeable, the latter only referring to the fact that a complete conical surface, as such, is not illustrated in FIGS. 5a-5c.)

In a particular example, the conical surfaces 500a, 500b are each oblique conical surfaces. In addition, FIG. 5a illustrates the conical surfaces 500a, 500b as being co-axial, but the axes of the conical surfaces 500a, 500b may be more generally parallel, and not necessarily co-axial.

The slopes of the primary bars relative to the axis of rotation can be globally characterized (and controlled) as a function of how oblique the conical surfaces 500a, 500b are. More particularly, the force component that tends to move the fiber strands 210 in one direction or the other along the traversing apparatus can be made to progressively increase from primary bar to primary bar as the traversing apparatus rotates by increasing how oblique the conical surfaces are, particularly by progressively increasing the slopes of the bars of the respective pluralities of primary bars. Progressively increasing the traversing force on the plurality of strands (in alternating positive and negative senses) can be helpful in overcoming sliding resistance between the fiber strands 210 and the primary and auxiliary bars over which the fiber strands 210 slide, thereby resulting in an even better deposition of the fiber strands in forming a cake.

FIGS. 5b and 5c further schematically illustrate the arrangement of the respective groups of primary bars on respective oblique conical surfaces. Both FIGS. 5b and 5c generally correspond to the illustration of traversing device 216 in FIG. 3, viewed along the axis X of shaft 250 in the direction indicated by line IV-IV in FIG. 3.

In FIG. 5b, frustoconical surface 500a (like that seen in FIG. 5a) extends into the page, such that base 502 generally corresponds with the plane of first bar support 222a, and distal (with respect to the reader) top surface 504 corresponds with the plane of second bar support 222b.

In FIG. 5c, frustoconical surface 500b (like that seen in FIG. 5a) extends relatively out of the page, such that base 506 corresponds with the plane of second bar support 222b, and proximal (with respect to the reader) top surface 508 corresponds with the plane of first bar support 222a.

In FIGS. 5a-c auxiliary bars 228a, 228b are selectively omitted for clarity.

FIG. 6 is a partial perspective view of traversing apparatus 216 in which first bar support 222a is omitted in order to illustrate the coplanarity of respective pairs of adjacent bars, as discussed above. In particular, as discussed above, it can be seen how the provision of auxiliary bar 228a between primary bars 224a and 226a defines a coplanar pair of bars 224a, 228a and a coplanar pair of bars 228a, 226a, instead of leaving just the above-described skewed positional relationship between primary bars 224a and 226a. The same effect can be seen in the provision of auxiliary bar 228b between primary bars 224c and 226c.

Although the present invention has been described above with reference to certain particular examples for the purpose of illustrating and explaining the invention, it is to be understood that the invention is not limited solely by reference to the specific details of those examples. More specifically, a person skilled in the art will readily appreciate that modifications and developments can be made in the preferred embodiments without departing from the scope of the invention as defined in the accompanying claims.

1. A rotatable traversing apparatus for traversing at least one strand of fibers while the at least one strand of fibers is wound onto a support, the traversing apparatus comprising:
first and second bar supports;
a first plurality of adjacent primary bars extending between a periphery of the first bar support and a periphery of the second bar support, respectively;
a second plurality of adjacent primary bars extending between a periphery of the first bar support and a periphery of the second bar support, respectively;
a pair of auxiliary bars, each auxiliary bar extending between a periphery of the first bar support and a periphery of the second bar support at a respective location circumferentially between a primary bar of the first plurality of primary bars and a primary bar of the second plurality of primary bars;
wherein respective pairs of adjacent primary and/or auxiliary bars are each coplanar; and
wherein the apparatus has an axis of rotation extending between the first and second bar supports and lying radially inward of the primary and auxiliary bars;
characterized in that each primary bar of the first plurality of adjacent primary bars lies on a surface of a first cone and each primary bar of the second plurality of adjacent primary bars lies on a surface of a second cone, the first cone and the second cone being oriented in substantially opposite directions, and
in that each primary bar of the first plurality of adjacent primary bars has a negative slope with respect to the axis of rotation in a direction along the axis of rotation from the first bar support towards the second bar support, and each primary bar of the second plurality of primary bars has a positive slope with respect to the axis of rotation in a direction along the axis of rotation from the first bar support towards the second bar support, and each auxiliary bar is arranged between the first and second pluralities of adjacent primary bars to provide a smooth positional transition therebetween.

2. The apparatus of claim 1, further characterized in that at least one of the primary bars of the first plurality of adjacent primary bars having a negative slope with respect to the axis of rotation has a slope that is different from the slope of another one of the primary bars of the first plurality of adjacent primary bars having a negative slope.

3. The apparatus of claim 2, further characterized in that primary bars of the first plurality of adjacent primary bars each have a progressively different negative slope.

4. The apparatus of claim 1, further characterized in that at least one of the primary bars of the second plurality of adjacent primary bars having a positive slope with respect to the axis of rotation has a slope that is different from the slope of another one of the primary bars of the second plurality of adjacent primary bars having a positive slope.

5. The apparatus of claim 1, further characterized in that primary bars of the first plurality of adjacent primary bars each have a progressively different negative slope.

6. The apparatus of claim 1, further characterized in that the first and second cones are each oblique cones.

7. The apparatus of claim 1, characterized in that each of the primary and auxiliary bars are straight.

8. The apparatus according to claim 1, characterized in that a respective auxiliary bar extends from adjacent an end of a corresponding one of the primary bars of the first plurality of adjacent primary bars at the first bar support to adjacent an end of a corresponding one of the primary bars of the second plurality of adjacent primary bars at the second bar support, each auxiliary bar providing a continuous transition between the negative slope of the first plurality of adjacent primary bars and the positive slope of the second plurality of adjacent primary bars.

9. The apparatus according to claim 1, wherein the first and second bar supports are substantially parallel first and second plates, and the axis of rotation of the apparatus is oblique relative to a perpendicular between the first and second plates.

10. A system for winding at least one strand of fibers onto an elongate spindle, comprising:
a strand supply for continuously supplying the at least one strand of fibers;
a rotatably mounted spindle having an axis of rotation and being driven to rotate, the at least one strand being attached to the driven spindle so as to be wound thereon; and
a rotatably driven traversing apparatus constructed and arranged to displace the at least one strand of fibers in a reciprocating manner along an axial length of the spindle while the at least one strand is being wound upon the spindle, the traversing apparatus being in sliding contact with the at least one strand while being rotatably driven and an axis of rotation of the traversing apparatus being substantially parallel to the axis of rotation of the spindle;
characterized in that the traversing apparatus is a traversing apparatus according to claim 1.

11. The system according to claim 10, wherein the at least one strand is a glass fiber strand, the strand supply comprising:
a molten glass source;
a bushing assembly including a plurality of bushings through which molten glass is drawn to form a corresponding plurality of glass fibers; and a separating device for grouping a predetermined number of the glass fibers together to form the at least one glass fiber strand.

12. The system according to claim 11, further comprising a sizing device operably arranged to deposit a sizing composition on the plurality of glass fibers.

13. The system according to claim 11, wherein the separating device is a toothed comb for grouping a predetermined number of the glass fibers together between respective teeth to form the at least one glass fiber strand.

14. The system according to claim 10, wherein the strand supply supplies a plurality of fiber strands, and characterized in that the traversing apparatus is constructed and arranged to substantially maintain a predetermined spacing between respective ones of the plurality of fiber strands as the plurality of fiber strands is wound onto the spindle.

15. A method of traversing a plurality of spaced apart and generally coplanar strands in a reciprocating linear movement, characterized in that the method comprises:
placing the plurality of strands under tension;
providing a rotatable traversing apparatus according to claim 1 in contact with the plurality of strands such that the plurality of strands contacts respective adjacent primary and auxiliary bars of the traversing device in sequence as the traversing device rotates;
advancing the plurality of strands in a first direction from the first bar support of the traversing device towards the second bar support of the traversing device by bringing the first plurality of adjacent primary bars having a negative slope into sequential contact with the plurality of strands by rotating the traversing device; and
advancing the plurality of strands in a second direction from the second bar support of the traversing device towards the first bar support of the traversing device by bringing the second plurality of adjacent primary bars having a positive slope into sequential contact with the plurality of strands by further rotating the traversing device;
characterized in that the method includes a step of transitioning the advancing plurality of strands between the first and second directions by bringing a respective one of the pair of auxiliary bars located circumferentially between the first and second pluralities of adjacent primary bars into contact with the plurality of strands, each auxiliary bar being arranged to provide a continuous transition between the slope of the first plurality of primary bars and the slope of the second plurality of primary bars; and
further characterized in that a velocity at which the plurality of strands slides along the bars of the traversing device in the first and second directions is at least partly a function of the slope of the respective bars of the first and second pluralities of primary bars.

16. The method according to claim 15, characterized in that it further comprises controlling the transitioning of the plurality of strands by controlling the obliqueness of the first and second cones.
